(19) United States
(12) Patent Application Publication
(10) Pub. No.: US 2016/0180483 A1
(43) Pub. Date: Jun. 23, 2016

(54) Electronic Medical Evaluation Software

(71) Applicant: Prime Medical, LLC, Baton Rouge, LA (US)

(72) Inventors: Sean H. Connor, Baton Rouge, LA (US); Luke P. Lee, Baton Rouge, LA (US)

(73) Assignee: Prime Medical, LLC

(21) Appl. No.: 14/581,842

(22) Filed: Dec. 23, 2014

(51) Int. Cl. G06Q 50/22; G06F 19/00; G06Q 10/10

(52) U.S. Cl. CPC G06Q 50/22; G06Q 10/105; G06F 19/3418

(57) ABSTRACT

A request to perform a medical procedure on an employee is received. The request is transmit to a medical clinic authorized to perform the requested medical procedure on the employee. A result of the medical procedure and confidential medical information associated with the employee is received from the medical clinic. The result of the medical procedure is provided to the employer, wherein the employer is unable to access the confidential medical information.

### FIELD OF THE INVENTION

The present invention relates generally to an electronic medical evaluation system.

### BACKGROUND OF THE INVENTION

Employers who hire employees to perform demanding jobs often need those employees to pass various medical exams and tests prior to employment to determine whether or not the employees are medically fit to perform the duties of the job. However, it requires a lot of time and other resources for an employer to determine the whether an employee has taken, passed, or failed the medical exams. The employer needs to call the employee and medical providers to make an accurate determination. This process can become unduly burdensome for the employer especially as the number of employees being hired grows.

### BRIEF SUMMARY OF THE INVENTION

The invention generally relates to an integrated electronic medical evaluation reporting system. A request to perform a medical procedure (e.g. examination, evaluation, etc.) on an employee is received. The request is transmit to a medical clinic authorized to perform the requested medical procedure on the employee. A result of the medical procedure and confidential medical information associated with the employee is received from the medical clinic. The result of the medical procedure is provided to the employer, wherein the employer is unable to access the confidential detailed medical information.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of an electronic medical evaluation system, according to an example embodiment.

FIG. 2 is an example employer interface of electronic medical evaluation system, according to an embodiment.

FIG. 3 is another example employer interface of electronic medical evaluation system, according to an embodiment.

FIG. 4 is an example clinic interface of electronic medical evaluation system, according to an embodiment.

FIG. 5 is another example clinic interface of electronic medical evaluation system, according to an embodiment.

FIG. 6 is an example reviewer interface of electronic medical evaluation system, according to an embodiment.

FIG. 7 is another example reviewer interface of electronic medical evaluation system, according to an embodiment.

FIG. 8 is a flowchart illustrating a process executed by electronic medical evaluation system, according to an example embodiment.

FIG. 9 is a flowchart illustrating an example review process, according to an embodiment.

### DETAILED DESCRIPTION OF THE INVENTION

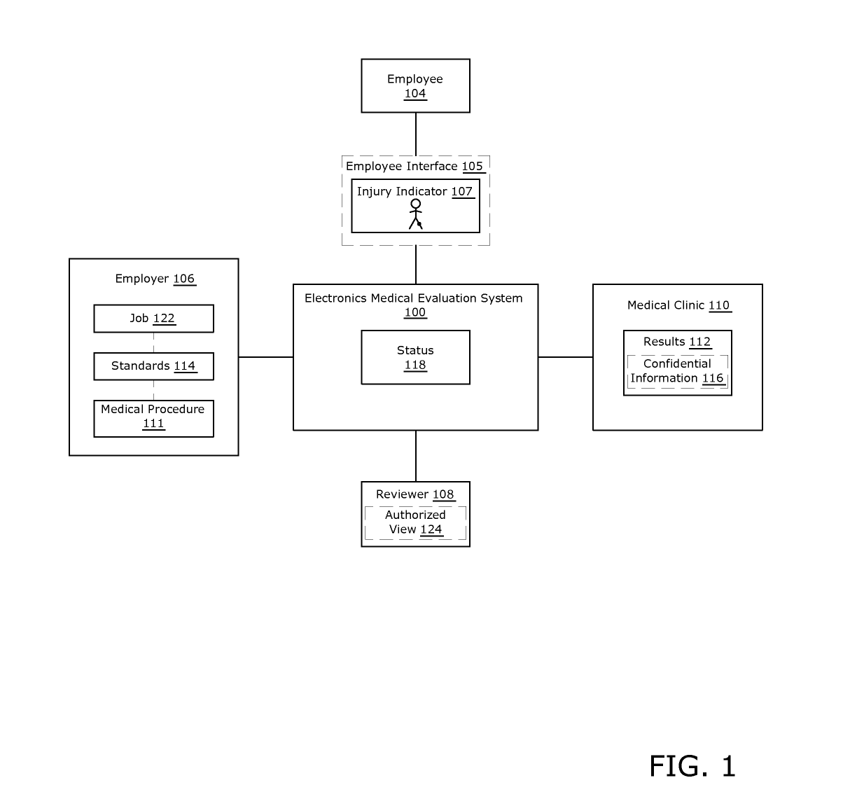

FIG. 1 is a block diagram of an electronic medical evaluation system 100, according to an example embodiment. The electronic medical evaluation system 100 is a system that provides coordination and varied levels access to medical information of employees 104, employers 106, reviewers 108, and medical clinics 110.

An employer 106 may request that an employee 104 undergo a medical procedure 111. Medical procedure 111 may be required by employer 106 to ensure that employee 104 is physically able to perform a job 122.

The electronic medical evaluation system 100 provides a centralized system by which the employer 106 is able track a status 118 and results 112 associated with the requested medical procedure 111. The electronic medical evaluation system 100 may provide the medical status 118 and results 112 associated with the performance of the requested medical procedure 111 to an employer 106. As described herein, electronic medical evaluation system 100 may allow an employer 106 to request multiple medical procedures 111 for one or more employees 104.

The electronic medical evaluation system 100 may protect the medical rights of the employee 104 by preventing the employer 106 from gaining access to any confidential information 116 about the employee 104 to which the employer 106 is not entitled while still enabling the employer 106 real-time access the status 118 and results 112. A reviewer 108 may redact or select a portion of results 112 and/or confidential information 116 to provide to or share with employer 106 in an authorized view 124 to ensure employer 106 does not view any confidential information 116 to which employer 106 is not entitled.

The electronic medical evaluation system 100 may ensure that medical clinics 110 are adhering to the standards of care 114 (standards 114) of the employer 106 for the performance of medical procedure 111. In an embodiment, standards 114 may provide guidelines or requirements as determined by employer 106 (or other organization) on how medical procedure 111 is to be performed. A reviewer 108 may review the results 112 and confidential information 116 to ensure that the standards 114 have been met by the medical clinic 110. Based on the evaluation, the reviewer 108 may accept, decline, or request additional information with regard to the results 112 provided by a medical clinic 110. The electronic medical evaluation system 100 may allow employers 106 to ensure that consistent medical care in accordance with standards 114 is being provided to employee 104 regardless of where or who is providing the medical care.

In an embodiment, two different employers 106 may have different standards 114 for the same medical procedure 111. Or for example, one employer 106 may have a standard 114 for a medical procedure 111 that is being performed on two different employees 104 in two different states by two different medical clinics 110. The electronic medical evaluation system 100, through the review process described herein, may ensure that the proper standard of care 114 is being met by medical clinics 110 for each employer 106.

Employer 106 may be a company or other organization that hires employees 104 to perform jobs 122. Job 122 may be a position, duty, or task employee 104 may be required to perform as part of an employment or other agreement with employer 106. In an example embodiment, the performance of job 122 may require employee 104 be in a particular physical or mental state. For example, job 122 may require employee 104 be able to lift objects of a certain weight, or that employee 104 have a particular vision measurement (e.g., such as 20/20 vision). Or for example, employer 106 may require that all employees 104, regardless of job 122, be given drug tests. In order to ensure employees 104 meet the requirements of an employer 106 and/or job 122, employer 106 may require that employee 104 undergo one or more medical procedures 111 to ensure the fitness of employee 104 for performing job 122. The electronic medical evaluation system 100 may allow employer 106 to request the medical procedures 111 to be performed at a medical clinic 110 without having to call and set up an appointment with medical clinic 110.

Medical procedure 111 may be any medical procedure, test, or examination required or requested by employer 106 or employee 104. The results 112 of medical procedure 111 may be used to determine the employee's fitness to perform job 122. In an embodiment, passing medical procedure 111 may be a condition of employment or continued employment to perform job 122. Example medical procedures 111 include, but are not limited to, eye exam, hearing exam or audiograms, physical, drug tests, alcohol screening, blood tests, x-rays, stress test, psychiatric exams, x-rays, cat scans, MRIs, annual screenings, or other specialized exams or tests particular to performing job 122.

Employer 106 may have standards of care 114 (standards 114) for how one or more medical procedures 111 are performed. Standards 114 may be any requirement of employer 106 relating to how or which medical procedure 111 is performed. For example, standards 114 may include a requirement that a drug test 110 includes screening for a particular set and number of drugs. Or, for example, standards 114 may require that physical exams 110 for a first job 122 include a test to ensure whether employee 104 is able to lift a specified weight above his/her head, and that physical exams 110 for a second job 122 does not require such a test or tests a different weight. In an embodiment, standards 114 may include employer specific guidelines, other organizational guidelines, and/or laws regulating the performance of medical procedure 111.

As described above, employee 104 may be a prospective employee of employer 106 who is required to pass one or more medical procedures 111 to be employed by in one or more jobs 122. In another embodiment, employee 104 may already be employed by employer 106 and may sustain an injury while working at job 122. Then, for example, medical procedures 111 may include any tests or procedures necessary to diagnose and/or treat the injury.

In an embodiment, employee 104 may communicate with electronic medical evaluation system 100 through an employee interface 105. For example, employee 104 may be able to access results 112 and/or confidential information 116 by way of employee interface 105. Employee interface 105 may allow for communication between employee 104 and reviewer 108 and/or medical clinic 110. In an embodiment, the communication may be deemed either confidential (inaccessible to employer 106), or non-confidential (to which employer 106 has access).

Employee interface 105 may allow employee 104 to indicate an injury by way of an injury indicator 107 which preferably is comprised of a body diagram. This body diagram may also be used in the interfaces for the data entry by the reviewer 108, medical clinic 110 and/or employer 106. In an embodiment, injury indicator 107 may provide employee 104 with a skeleton or other representation of a human figure and allow employee 104 to click to indicate the location of the injury or pain. For example, as shown, the X may indicate a pain in the employee's right knee. Employee interface 105 may be accessible to employee by way of a web browser or mobile application.

In another embodiment, employee interface 105 may only provide access to employee medical information. Information about employee 104 may be provided by employer 106 and/or medical clinic 110. For example, employer 106 and/or medical clinic 110 may access to injury indicator 107 via their own interface (e.g., dashboard) with electronic medical evaluation system 100.

The electronic medical evaluation system 100 may enable employer 106 or employee 104 to request medical procedures 111. After the receipt of a request for medical procedure 111, electronic medical evaluation system 100 may designate which medical clinic 110 is to perform the medical procedure 111. For example, employer 106 may be associated with or may contract with one or more medical clinics 110. Upon receipt of a request for one or more medical procedures 111, electronic medical evaluation system 100 may provide the requestor (employer 106 or employee 104) a list of one or more medical clinics 110 authorized to perform the requested procedures 111. The electronic medical evaluation system 100 may select the medical clinic(s) 110 based on any number of factors, including, location of job 122, location of employer 106, location of employee 104, cost, medical clinic's ability to perform the request procedures 111, whether or not employee 104 has visited the clinic before, wait time or busyness of medical clinics, and employee's preference.

In an embodiment, electronic medical evaluation system 100 may automatically select which medical clinic(s) 110 are to perform which medical procedure(s) for employee 104. The electronic medical evaluation system 100 may allow employer 106 and/or employee 104 to override the initial selection with another approved medical clinic 110.

Medical clinic 110 may be a hospital, doctor's office, a doctor, nurse, or other health clinic or provider with medical personnel authorized or licensed to perform one or more requested medical procedure(s). In an embodiment, medical clinic 110 may include emergency personnel, such as an EMT (emergency medical technician), paramedic, or other individual, who provided medical care to employee 104.

The electronic medical evaluation system 100 may receive results 112 of medical procedures 111 from medical clinic 110. Results 112 may include information indicating whether employee 104 passed or failed a medical exam 111 such as a drug screening, a diagnosis of an injury or disease, and/or a prescribed method of treatment (e.g., prescription, rest, training, surgery, re-test, etc.).

The electronic medical evaluation system 100 may also allow medical clinic 110 to upload confidential information 116 about employee 104 as relating to the employee's medical condition or more specific information about the medical procedure 111 performed. Confidential information 116 may include any information that employer may not be authorized to view. The confidential information 116 may be stored and managed by the electronic medical evaluation system 100. For example, employers 106 may be restricted from which medical information about an employee 104 they are allowed to access. These restrictions may be due to laws or other occupational or medical regulations. Results 112, by contrast, may indicate the results 112 of medical procedures 111 or other relevant information employer 106 is allowed to see/access. For example, employer 106 may be notified with results 112 that employee 104 failed a drug test 111, but may not be notified as for which of the test drug(s) the employee 104 failed or the level of drugs found in the employee's system because that additional detail may be confidential information 116.

In an embodiment, a reviewer 108 may review results 112 and/or confidential information 116 (collectively referred to herein as “medical information”) before it is provided to employer 106. Reviewer 108 may be any medical personnel (e.g., doctors, nurses, or other trained personnel) that review medical information received from medical clinic 110 prior to the submission of that medical information to employer 106 through electronic medical evaluation system 100.

Reviewer 108 may, for example, review medical information (results 112 and confidential information 116) to ensure standards 114 of employer 106 have been met by medical clinic 110. As an example, in a drug test, reviewer 108 may ensure all the indicated drugs in standards 114 were tested for by medical clinic 110. Through the reviewing process, electronic medical evaluation system 100 allows employer 106 to know its standards are being met without accessing restricted confidential information 116 (which may be accessible to reviewer 108) and regardless of which medical clinic 110 is performing the medical evaluation.

Based on the medical information, reviewer 108 may authorize the results 112 indicating that all standards 114 have been met, and results 112 may be released to employer 106. Reviewer 108 may decline the results 112, indicating that medical clinic 110 failed to meet one or more standards 114. Or, reviewer 108 may need additional information from medical clinic 110, in which case reviewer 108 may communicate directly with medical clinic 110 through electronic medical evaluation system 100, without employer 106 being able to see the communication. For example, electronic medical evaluation system 100 may have an electronic medical record including results 112 and confidential information 116, to which reviewer 108 may attach a note or question for medical clinic 110. The communication between reviewer 108 and medical clinic 110 may be included as part of the employee's electronic medical record, but may automatically be marked as confidential information 116 inaccessible to employer 106. Employer 106 may however be able to see, in real-time, the status 118 of the review (e.g., authorized, declined, more info requested).

In an embodiment, reviewer 108 may select a portion of results 112 and/or confidential information 116 and generate an authorized view 124. Authorized view 124 may include, for example, a selection of confidential information 116 or redacted portion of confidential information 116 that reviewer 108 determines employer 106 is authorized to view. This may include sharing documents, or portions thereof, provided by medical clinic as confidential information 116 that may be tangential to or otherwise supportive of results 112. This determination as to which information employer 106 is authorized to view may be based upon its relevance to medical procedure 111 and/or an employee's fitness to work, and on a case-by-base basis.

For example, medical clinic 110 may upload a document with the information gathered from employee 104 as part of a physical exam. Results 112 may indicate that employee 104 failed a physical exam 111. Reviewer 108 may review confidential information 116, and determine employee 104 failed due to a previous arm injury and include this in authorized view 124. An x-ray of the injury however may remain confidential information 116, inaccessible to employer 106.

In another embodiment, reviewer 108 may generate a new document to provide to employer 106 as authorized view 124. For example, reviewer 108 may review confidential information 116 and may produce a new document that includes relevant information for employer 106 without revealing any information employer 106 is not authorized to view due to employee confidentiality.

Throughout the medical review process, electronic medical evaluation system 100 may provide employer 106 real-time access to a status 118 of each employee 104 associated with the employer 106. Status 118 may be a general indication as to which medical procedure(s) 111 have been performed by medical clinic 110 and/or reviewed by reviewer 108. For example, status 118 may indicate that a request for medical procedure(s) 111 has been received, the request has been assigned to medical clinic 110, the medical clinic 110 has performed one or more of the medical procedures 111, whether or not the reviewer 108 has reviewed results 112, or whether additional information has been requested by reviewer 108 from medical clinic 110 or by reviewer 108 or medical clinic 110 from employee. Similar to what is described above, electronic medical evaluation system 100 may enable confidential and secure communications between medical clinic 110 or reviewer 108 and employee 104, which is not accessible to employer 106.

The electronic medical evaluation system 100 may grant employee 104 access to all or selected portions of results 112 and confidential information 116. The level of access provided to employee 104 may be determined by laws, regulations, and/or standards 114 in various embodiments. In an embodiment, when applying for job 122, employee 104 may be directed to an interface of electronic medical evaluation system 100 through which employee 104 provides medical history information. This medical history information may then be stored by electronic medical evaluation system 100 as part of the employee's electronic medical record. Then, for example, if employee 104 changes companies, the employee's previous medical information (including previous medical procedures 111 and results 112) would already be within electronic medical evaluation system 100, making the hiring process easier for both employees and employers. For example, with employee 104 authorization, electronic medical evaluation system 100 may release previous results 112 from medical procedures 111 performed with a different employer 106 to a new employer 106 of employee 104.

In an embodiment, employee 104 may request medical procedures 111. For example, employee 104 may have suffered an injury while working on job 122. Then for example, employee 104 may indicate where on his/her body is the location of the injury. For example, in an embodiment, electronic medical evaluation system 100 may provide a skeleton or outline of a human body showing the human anatomy (“body diagram”) on which employee 104 may point and click to indicate the location of injury or location of medical attention requirement on the employee 104. The body diagram may also be displayed and used by the medical clinic 110, the reviewer 108 and/or the employer 106 during data entry in their corresponding interface. Employee 104 may also provide information regarding how/when/the extent of the injury. This feature may also be provided by or accessible to employer 106. In an embodiment, employee 104 may have access to results 112, confidential information 116, and requested medical procedures 111 via an interface of electronic medical evaluation system 100.

The electronic medical evaluation system 100 provides a centralized system by which employers 106 are able to track the medical status 118 of employees 104 across one or more job 122 and/or locations. The electronic medical evaluation system 100 may provide a firewall that prevents employer 106 from accessing confidential information 116 of employee 104 in according with any regulations that may apply, all the while ensuring that employer's standards of care 114 are met. The electronic medical evaluation system 100 may provide a central repository of medical information for employees 104 across various employers 106, with varied levels of access to that information based on the roles of each user (e.g., employer 106, employee 104, medical clinic 110, and reviewer 108).

The electronic medical evaluation system 100 may also allow for audits of medical information for employees 104 across the company of employer 106. For example, with injury tracking, an employer 106 may be able to determine that a large number of heat strokes occurred with employees 104 working on a particular job 122 in a particular location. Then, for example, employer 106 may take corrective action (e.g., teaching employees 104 how to rehydrate properly, improve ventilation, reduce working hours, etc.) to prevent or reduce future injury. Or for example, electronic medical evaluation system 100 may provide employers 106 with a tool by which they are able to response to inquiries by the Occupational, Safety, and Health Administration (OSHA) or other bodies that may request information about worker safety.

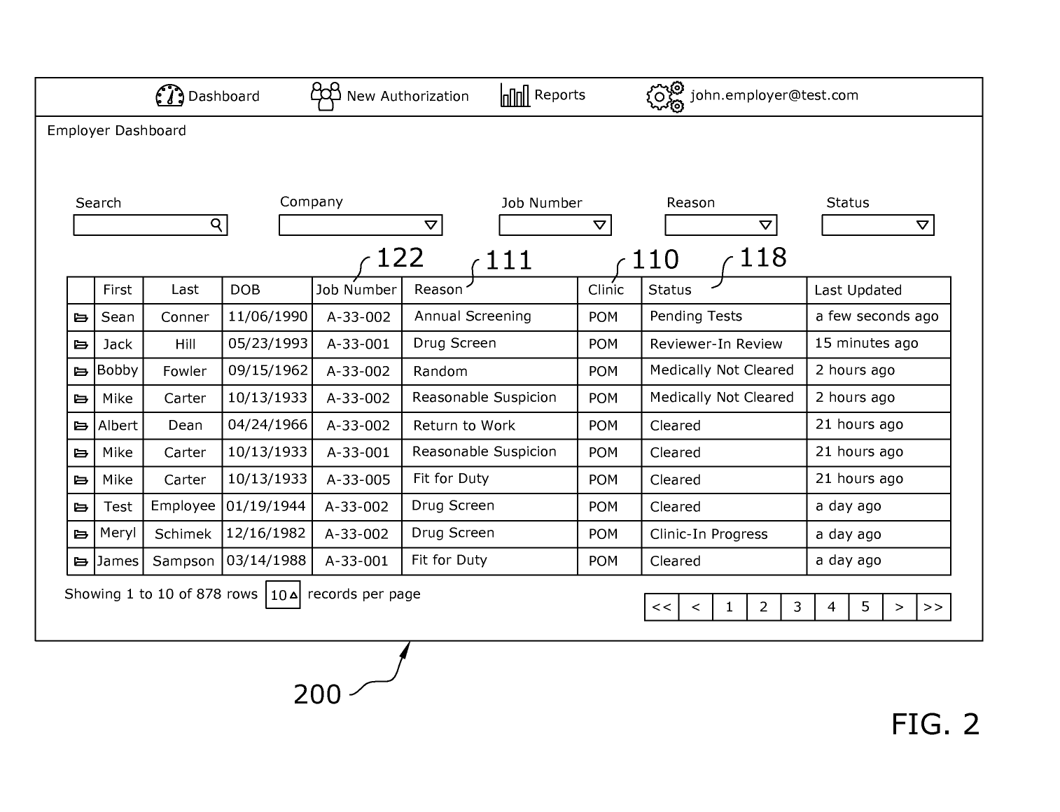

FIG. 2 is an example employer interface 200 of electronic medical evaluation system 100, according to an embodiment. Interface 200 is an example embodiment of an employer dashboard.

An employer 106, using employer dashboard is able to see the names of employees 104, their employee identifier, job numbers 122, the requested medical procedures 111 and/or reasons for requesting the procedure, which clinic 110 has been assigned the employee to perform the procedures, the status 118, and a time when the information was last updated.

Interface 200 may allow employer 106 to search for information, sort by job numbers, reasons, location, status, or any other information. In other embodiments, interface 200 may include additional and/or different information, such as an employee number, date requested, and cost (e.g., of the requested/performed procedures).

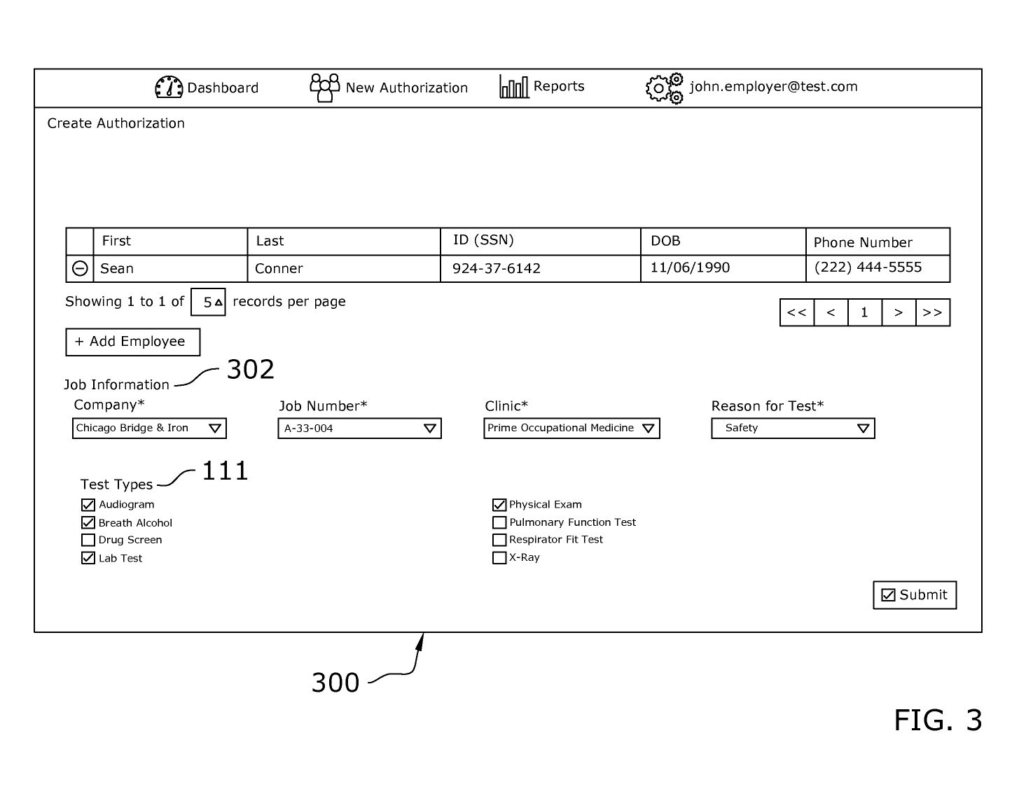

FIG. 3 is another example employer interface 300 of electronic medical evaluation system 100, according to an embodiment. Interface 300 is an example embodiment of a request interface where an employer 106 may request which medical procedures 111 are to be performed on an employee 104.

Employer 106 may, for example, select or provide one or more employees 104 for whom to request a selection of test types (medical procedures 111). As shown employer 106 may also specify job information 302. Job information 302 may include optional information employer 106 desires to provide. For example, the company field may indicate for which company employee 104 works. In an embodiment, employer 106 may be a main contractor and may have one or more sub-contractors working on the same project or job 122. In the company field, electronic medical evaluation system 100 may track to which contracting and/or sub-contracting company employee 104 is associated.

Employer 106 may also select which medical clinic 110 employer desires, or electronic medical evaluation system 100 may automatically provide clinic choices or a clinic selection. Employer 106 may also provide a reason for the test.

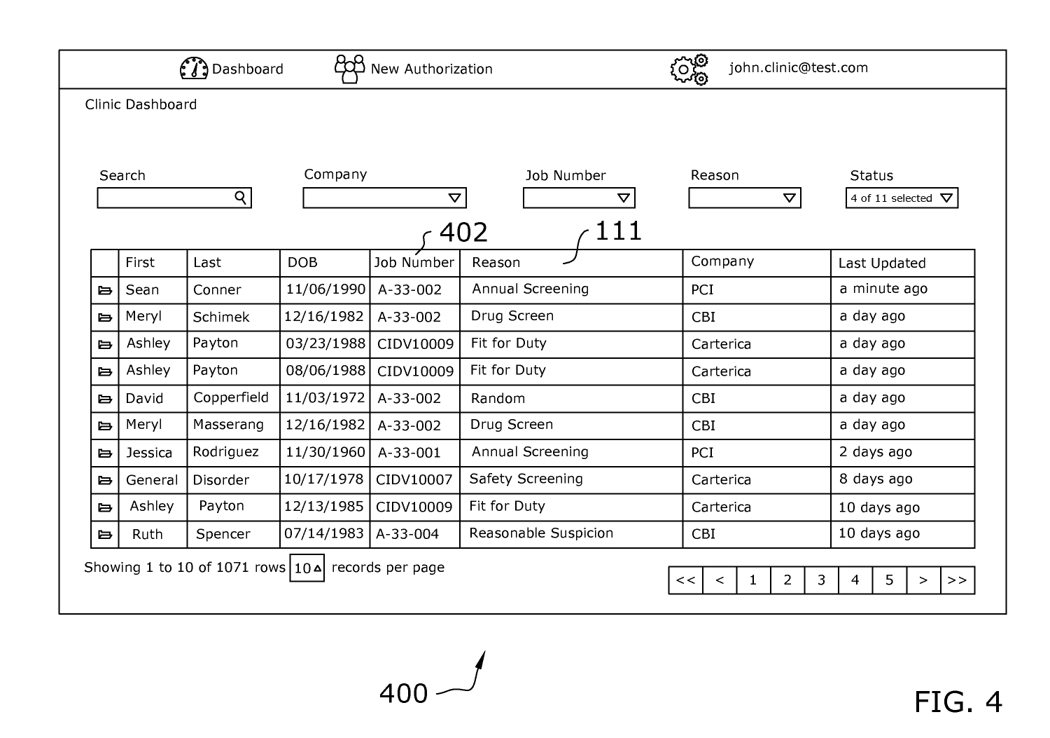

FIG. 4 is an example clinic interface 400 of electronic medical evaluation system 100, according to an embodiment. Interface 400 is an example embodiment of a clinic dashboard. A medical clinic 110, using clinic dashboard, is able to see the names of employees 104 assigned to the clinic by way of electronic medical evaluation system 100. Job number 402 may correspond to a job 122 of employer 106 or may an electronic medical evaluation system 100 internal job number, or clinic job number associated with the performance of one or more medical procedures 111 on the employee 104. Company field 106 may indicate the employer 106 of FIG. 1.

Similar to what was described above with respect to interface 200, medical clinic personnel may see different information and/or sort by any of the information presented. In an embodiment, the information presented on each or any interface may be toggled or adjusted by the respective employer 106, employee 104, reviewer 108, or medical clinic 110 accessing electronic medical evaluation system 100 via that interface as to which information is displayed on the interface. In an embodiment, electronic medical evaluation system 100 may be accessible to any of the parties via a web-based or mobile-device based interface.

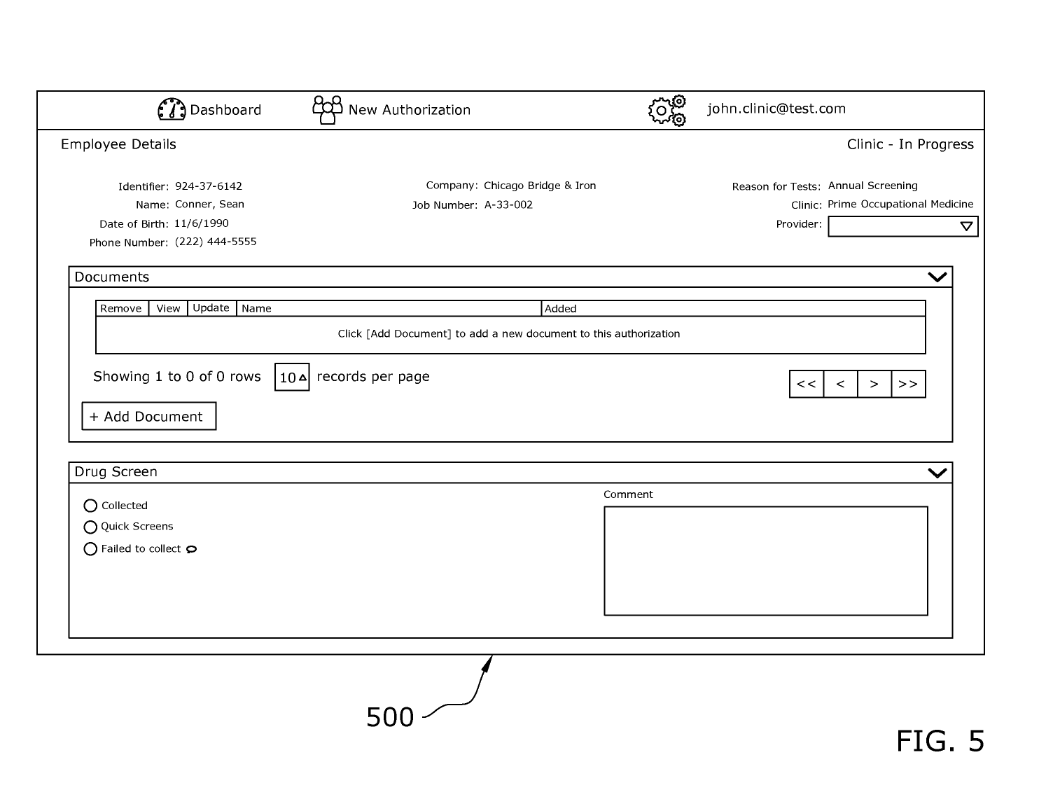

FIG. 5 is another example clinic interface 500 of electronic medical evaluation system 100, according to an embodiment. Interface 500 is an example embodiment of another clinic interface. The electronic medical evaluation system 100 may provide interface 500 to allow medical clinics 110 to update the status of medical procedures 111. Medical clinic 110 may also upload documents that may or may not include confidential information 116.

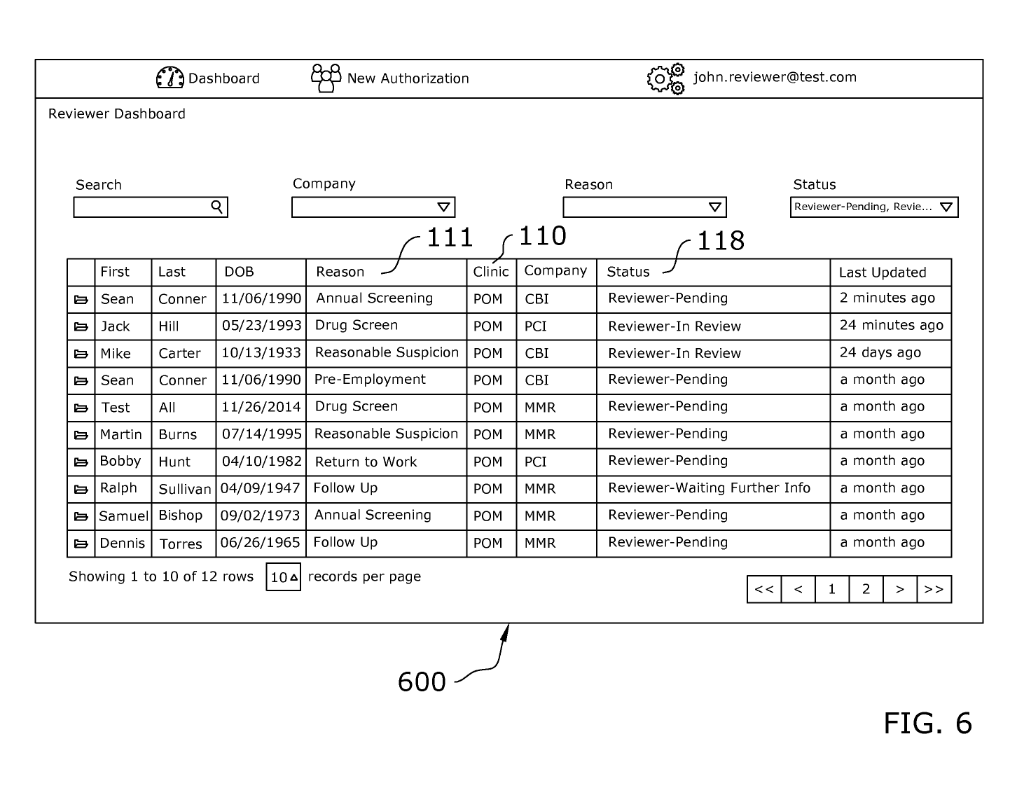

FIG. 6 is an example reviewer interface 600 of electronic medical evaluation system 100, according to an embodiment. Interface 600 is an example embodiment of a reviewer dashboard. A reviewer 108 may see which employees have been assigned to the reviewer 108 and the status of review. By clicking on the records, reviewer 108 may review in greater detail the medical information provided by medical clinic 110.

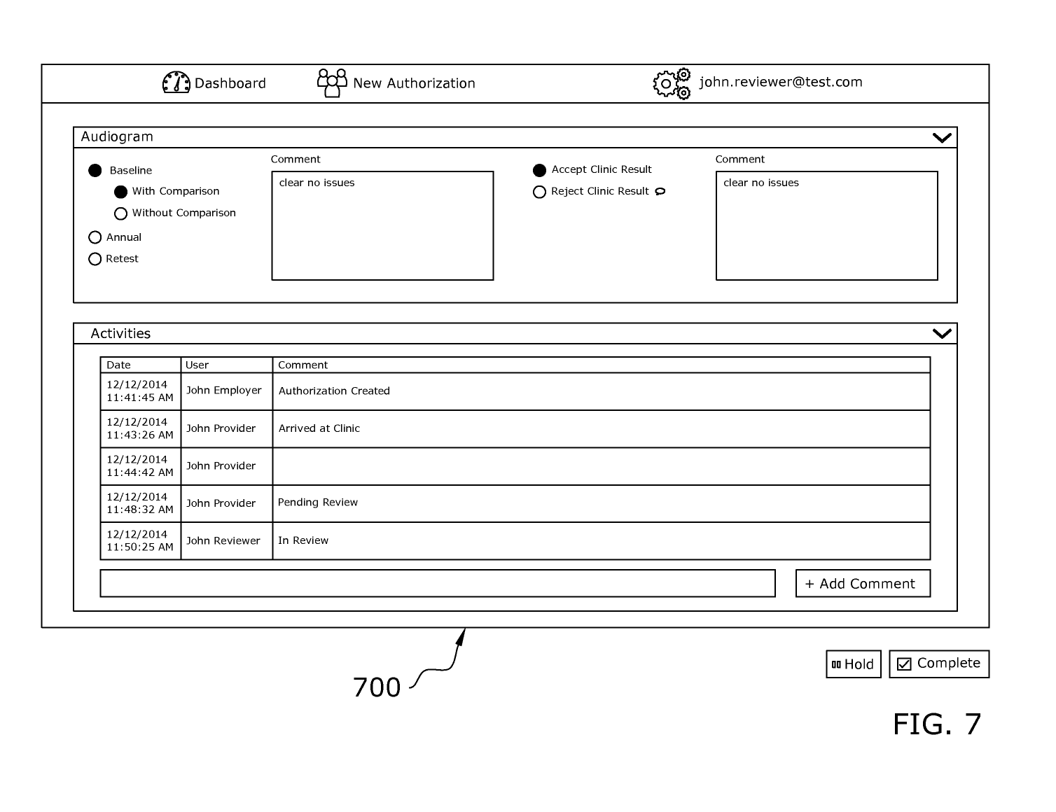

FIG. 7 is another example reviewer interface 700 of electronic medical evaluation system 100, according to an embodiment. Interface 700 is an example embodiment of a reviewer interface. By way of reviewer interface 700, a reviewer may see the information provided by clinic, and may enter notes with regard to the results 112 and/or confidential information 116 provided. Reviewer 108 may also be able to see a list of activities and when the activities took place with regard to an employee 104.

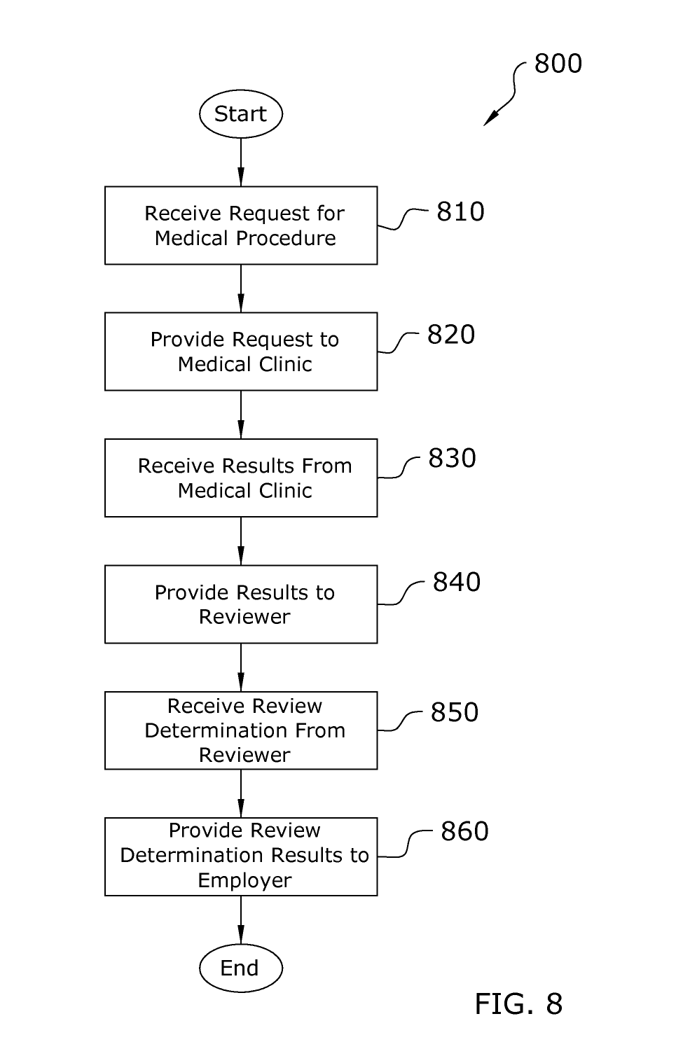

FIG. 8 is a flowchart 800 illustrating a process executed by electronic medical evaluation system 100, according to an example embodiment. At step 810, a request is received for a medical procedure. For example, the electronic medical evaluation system 100 may receive an employer 106 request for medical procedures 111 to be performed on employee 104. Or, for example, employee 104 may report an injury by way of employee interface 105 that requires one or more medical procedures 111. In an embodiment, employee 104 may not be required to provide any information directly to electronic medical evaluation system 100, but instead may provide information to employer 106 and/or medical clinic 110 as may be necessary to request and/or perform medical procedures 111.

At step 820, the request is provided to a medical clinic. For example, the electronic medical evaluation system 100 may provide or transmit the request to medical clinic 110. In an embodiment, electronic medical evaluation system 100 may automatically schedule an appointment for employee 104 and notify employee 104 and update status 118 with the appointment date/time. For example, electronic medical evaluation system 100 may coordinate an appointment based on an electronic calendar of employee 104 and/or medical clinic 110. In another embodiment, electronic medical evaluation system 100 may instruct medical clinic 110 to contact employee 104 to schedule an appointment, or vice versa. In another embodiment, no appointment may be scheduled with medical clinic 110, a new entry for an employee 104 on the medical clinic 110 dashboard may serve as notification to medical clinic 110 to expect employee 104.

At step 830, results are received from the medical clinic. For example, after one or more medical procedures 111 are performed or attempted performance (which may fail for any number of reasons) by medical clinic 110, results of the performance may be uploaded to otherwise provided to electronic medical evaluation system 100.

At step 840, the results are provided to a reviewer. For example, results 112 and confidential information 116 (if any) may be provide to reviewer 108. Confidential information 116 may include any information that supports or may otherwise be associated with the finding of results 112, but which may be protected by doctor-patient confidentiality, or for other reasons should not be accessible to employer 106.

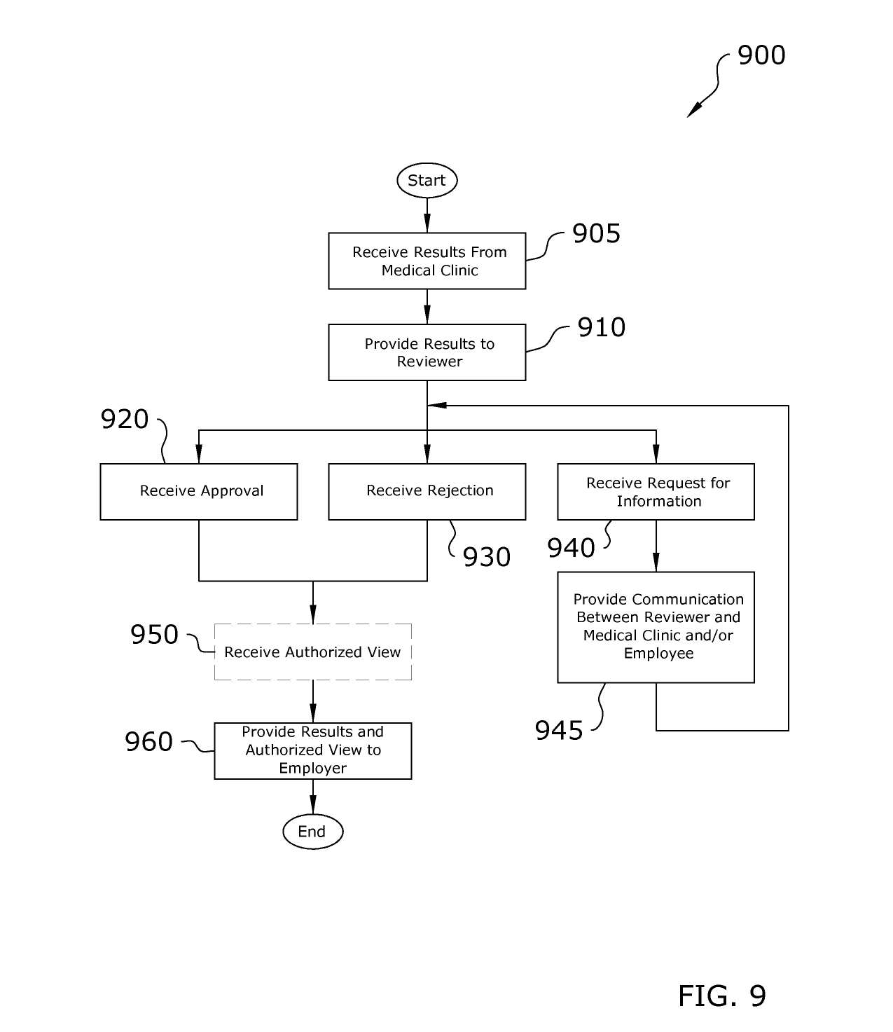

At step 850, a review determination is received from the reviewer. For example, reviewer 108 may perform a review process to ensure that the performance of medical procedures 111 conforms to standards 114. The review process is described in greater detail with regard to FIG. 9.

At step 860, the review determination and results are provided to the employer. For example, if results 112 are approved or rejected by reviewer 108, the results 112 and approval/rejection notice of reviewer may be provided to employer 106. However throughout the process, electronic medical evaluation system 100 may continually update status 118 indicating the last performed task or action with regard to the requested medical procedure(s) 111. As such, electronic medical evaluation system 100 provides employer 106 to real-time status 118 information without needing to separately contact employee 104, medical clinic 110, or reviewer 108.

FIG. 9 is a flowchart 900 illustrating an example review process, according to an embodiment. At step 905, results are received from a medical clinic. For example, a medical clinic 110 may provide results 112 and confidential information 116 to electronic medical evaluation system 100. In an embodiment, results 112 may indicate whether employee 104 passed/failed a particular exam, and confidential information 116 may include more detailed results as to why the employee 104 passed/failed.

At step 910, results are provided to reviewer 108. For example, electronic medical evaluation system 100 may provide results 112 and confidential information 116 to reviewer 108 for review. Prior to review by reviewer 108, results 112 may be inaccessible to employer 106. However, status 118 may be updated to indicate the results 112 have been received and are currently await or under review. During the review process, reviewer 108 may review results 112 and confidential information 116 to ensure standards 114 of employer 106 have been met for each medical procedure 111 performed by medical clinic 110. In an embodiment, the review may be performed on a procedure-by-procedure basis.

At step 920, an approval is received from the reviewer. For example, if reviewer 108 determines that the performance of medical procedure is in accordance with standards 114, reviewer 108 may approve results 112.

At step 930, a rejection is received from the reviewer. For example, if reviewer 108 determines that the performance of medical procedure is not in accordance with standards 114, reviewer 108 may reject results 112. The electronic medical evaluation system 100 may receive from reviewer 108 any reasons for the rejection, which may be provided to employer 106 and/or medical clinic 110.

At step 940, a request for additional information is received from the reviewer. For example, reviewer 108 may have questions or may not have enough information to determine whether or not the performance of medical procedures 111 was done in accordance with standards 114. The reviewer 108 may indicate as such, and electronic medical evaluation system 100 may update status 118 accordingly.

At step 945, communication between the reviewer and the medical clinic and/or employee is provided. For example, electronic medical evaluation system 100 may provide channels for confidential communication (e.g., not accessible to employer 106) between reviewer 108 and medical clinic 110 and/or employee 104. The electronic medical evaluation system 100 may allow for e-mail, video, voice, chat, or other communication between the parties. This communication may be stored with an employee's electronic medical record, but may not be made accessible to employer 106.

At 950, an authorized view may be received. Authorized view 124 may be any confidential information 116 provided by medical clinic 110 and/or employee 104 that reviewer 108 determines employer 106 is authorized to view. In an embodiment, reviewer 108 may have discretion to share necessary medical information provided by medical clinic 110 with employer 106. The information may be redacted, cut, or copied, such that only that portion of the information that is allowable (e.g., based on laws, standards 114, or other guidelines) is provided.

At 960, the results are provided to the employer. For example, electronic medical evaluation system 100 may transmit a notification that the requested medical procedures 111 have been performed by medical clinic 110 and have been reviewed by reviewer 108. The electronic medical evaluation system 100 may then enable employer 106 to access results 112 and authorized view 124.

The present invention may be utilized upon any telecommunications network capable of transmitting data including voice data and other types of electronic data. Examples of suitable telecommunications networks for the present invention include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). The present invention may communicate via a single telecommunications network or multiple telecommunications networks concurrently. Various protocols may be utilized by the electronic devices for communications such as but not limited to HTTP, SMTP, FTP and WAP (wireless Application Protocol). The present invention may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and Internet service providers.

The Internet is an exemplary telecommunications network for the present invention. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

The central communication unit may be comprised of any central communication site where communications are preferably established with. The central communication units may be comprised of a server computer, cloud based computer, virtual computer, home computer or other computer system capable of receiving and transmitting data via IP networks and the telecommunication networks. As can be appreciated, a modem or other communication device may be required between each of the central communication units and the corresponding telecommunication networks. The central communication unit may be comprised of any electronic system capable of receiving and transmitting information (e.g. voice data, computer data, etc.).

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

The invention claimed is:

1. A method, comprising:
receiving a request to perform a medical procedure on an employee, wherein the medical procedure is required by an employer of the employee, and wherein the medical procedure is associated with an ability of the employee to perform a job for the employer;
transmitting the request to a medical clinic authorized to perform the requested medical procedure on the employee;
receiving from the medical clinic, a result of the medical procedure and confidential medical information associated with the employee; and
providing to the employer the result of the medical procedure, wherein the employer is unable to access the confidential medical information.

2. The method of claim 1, wherein the employer is a potential employer of the employee, and the employee is a candidate applying for the job.

3. The method of claim 1, wherein the medical procedure is required by the employer as a result of an injury sustained by the employee while performing the job.

4. The method of claim 3, further comprising, receiving from the employer or employee an indication of a location of the injury on the employee.

5. The method of claim 1, further comprising:
receiving an authorized view of the result and the confidential information from a reviewer that has selected a portion of the confidential medical information that the employer is authorized to view, and
wherein the providing comprises providing to the employer the authorized view of the result including the selected portion of the confidential information.

6. The method of claim 1, wherein the providing comprises:
providing to the employer a status of the medical procedure, wherein the status includes whether or not the medical procedure has been performed by the medical clinic.

7. The method of claim 1, further comprising:
receiving an authorization from a reviewer that the medical clinic performed the medical procedure in accordance with a standard for a performance of the medical procedure has indicated by the employer.

8. The method of claim 1, wherein the medical procedure comprises one of: an eye exam, hearing exam, physical, or drug test.

9. The method of claim 1, wherein the receiving the request comprises:
receiving a plurality of requests from a plurality of employers requesting a plurality medical procedures on a plurality of employees.

10. The method of claim 9, wherein each of the plurality of employers has access to results of the medical procedures of only those employees associated with the respective employer.

11. The method of claim 9, further comprising:
tracking a status of the medical procedures, wherein the medical procedures are performed by a plurality of medical clinics that are geographically disbursed across two or more states.

12. The method of claim 9, further comprising:
receiving from a first employer and a second employer, of the plurality of employers, a standard for a performance of a selected one of the medical procedures by the medical clinics, wherein the standards of the first employer for the performance of the medical procedure is different from the standards for the performance of the medical procedure of the second employer.

13. The method of claim 12, further comprising:
receiving, from a reviewer, an indication as to whether a performance of the selected medical procedure by a first one the medical clinics on a first employee corresponds to the standard of the first employer, wherein the first employee is associated with the first employer.

14. A system comprising one or more processors coupled to a non-transitory memory, that when executed perform the following:
receiving a request to perform a medical procedure on an employee, wherein the medical procedure is required by an employer of the employee, and wherein the medical procedure is associated with an ability of the employee to perform a job for the employer;
transmitting the request to a medical clinic authorized to perform the requested medical procedure on the employee;
receiving from the medical clinic, a result of the medical procedure and confidential medical information associated with the employee; and
providing to the employer the result of the medical procedure, wherein the employer is unable to access the confidential medical information.

15. The system of claim 14, wherein the one or more processors when executed further perform:
receiving an authorized view of the result and the confidential information from a reviewer that has selected a portion of the confidential medical information that the employer is authorized to view, and
wherein the providing comprises providing to the employer the authorized view of the result including the selected portion of the confidential information.

16. The system of claim 14, wherein the one or more processors when executed further perform:
receiving a rejection from a reviewer indicating that the medical clinic has not performed the medical procedure in accordance with a standard for the performance of the medical procedure as indicated by the employer.

17. The system of claim 14, wherein the one or more processors when executed further perform:
receiving an authorization from a reviewer that the medical clinic performed the medical procedure in accordance with a standard for a performance of the medical procedure has indicated by the employer.

18. A computer program product tangibly embodied on a non-transitory computer readable medium that when executed by one or more processors, causes the one or more processors to:
receive a request to perform a medical procedure on an employee, wherein the medical procedure is required by an employer of the employee, and wherein the medical procedure is associated with an ability of the employee to perform a job for the employer;
transmit the request to a medical clinic authorized to perform the requested medical procedure on the employee;
receive from the medical clinic, a result of the medical procedure and confidential medical information associated with the employee; and
provide to the employer the result of the medical procedure, wherein the employer is unable to access the confidential medical information.

19. The computer program product of claim 18, further configured to cause the one or more processors to:
receive an authorized view of the result and the confidential information from a reviewer that has selected a portion of the confidential medical information that the employer is authorized to view, and
wherein the providing comprises providing to the employer the authorized view of the result including the selected portion of the confidential information.

20. The computer program product of claim 18, further configured to cause the one or more processors to:
provide to the employer a status of the medical procedure, wherein the status includes whether or not the medical procedure has been performed by the medical clinic.
